(19) United States
(12) Patent Application Publication
(10) Pub. No.: US 2022/0013946 A1
(43) Pub. Date: Jan. 13, 2022

(54) CONNECTOR HOUSING

(71) Applicants: YAZAKI CORPORATION, Tokyo (JP); HONDA MOTOR CO., LTD., Tokyo (JP)

(72) Inventors: Daisuke Fujihira, Asaka-shi (JP); Masahiro Teranishi, Asaka-shI (JP); Tomoyuki Miyakawa, Utsunomiya-shi (JP); Kozo Oishi, Utsunomiya-shi (JP); Hoshina Chisaka, Utsunomiya-shi (JP)

(21) Appl. No.: 17/485,242

(22) Filed: Sep. 24, 2021

Related U.S. Application Data
(63) Continuation of application No. PCT/JP2020/008727, filed on Mar. 2, 2020.

(30) Foreign Application Priority Data
Mar. 26, 2019 (JP) 2019-059304

(51) Int. Cl. H01R 13/436; H01R 13/422; H01R 13/639; H01R 13/629; H01R 13/502

(52) U.S. Cl. CPC H01R 13/436; H01R 13/4223; H01R 13/502; H01R 13/629; H01R 13/639

(57) ABSTRACT

The connector housing includes: the terminal reception chambers, the terminal insertion holes; the lock portions; and the coupling portion connecting a pair of the lock portions each belonging to each of a pair of the terminal reception chambers located adjacent to each other. The coupling portion is connected to a first partition wall partitioning a pair of the terminal insertion holes corresponding to the pair of the terminal reception chambers. The coupling portion has a groove extending along a direction to receive the each terminal.

### CROSS-REFERENCE TO RELATED APPLICATIONS

This is a continuation of International Application No. PCT/JP2020/008727 filed on Mar. 2, 2020, and claims priority from Japanese Patent Application No. 2019-059304 filed on Mar. 26, 2019, the entire content of which is incorporated herein by reference.

### TECHNICAL FIELD

The present invention relates to a connector housing.

### BACKGROUND ART

There has been heretofore proposed a connector housing having terminal reception chambers capable of receiving terminals which have been attached to ends of electric cables. Lock mechanisms (e.g. lances) for retaining the terminals at predetermined positions inside the terminal reception chambers may be used in such a type connector housing.

As for details of the above connector housing, refer to JP 2009-224084 A.

Recently, there is a tendency that the connector housing is required to be also reduced in size as a space for receiving an electrical component in an apparatus (e.g. a vehicle such as a car or a motorcycle) where the connector housing is actually used is reduced. Here, generally, when the size of the connector housing is reduced, the size of each of the lock mechanisms such as the lances is also reduced, and force (hereinafter also referred to as “lock force”) trying to retain the terminals at the predetermined positions against external force is also reduced. Accordingly, when the size of the connector housing is carelessly reduced, there is a possibility that the terminals cannot be retained properly inside the terminal reception chambers to thereby impair the function as the connector housing.

### SUMMARY OF INVENTION

Aspect of non-limiting embodiments of the present disclosure relates to provide a connector housing which can properly retain the terminals inside the terminal reception chambers compatibly with reduction in size of the connector housing.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a connector housing comprising:

a plurality of terminal reception chambers;

a plurality of terminal insertion holes each being located to communicate with each of the plurality of the terminal reception chambers, the plurality of the terminal insertion holes each being configured to allow each terminal to be received in each of the terminal reception chambers to pass through its inside before the each terminal being received in the each of the terminal reception chambers;

a plurality of lock portions each being located in each of the plurality of terminal reception chambers, the plurality of lock portions each being configured to be elastically deformed in a direction to leave from the each terminal in the middle of reception to the each of the terminal reception chambers and to be elastically recovered in a direction to approach the each terminal to lock the each terminal upon the reception of the each terminal being completed; and

a coupling portion connecting a pair of the lock portions each belonging to each of a pair of the terminal reception chambers located adjacent to each other,

the coupling portion being connected to a first partition wall partitioning a pair of the terminal insertion holes corresponding to the pair of the terminal reception chambers, the coupling portion having a groove extending along a direction to receive the each terminal.

### BRIEF DESCRIPTION OF DRAWINGS

Exemplary embodiment(s) of the present invention will be described in detail based on the following figures, wherein:

FIG. 1 is an exploded perspective view of a connector fitting body including a female housing according to an embodiment of the present invention;

FIG. 2A is a perspective view of a male housing shown in FIG. 1, and FIG. 2B is a perspective view of the female housing shown in FIG. 1;

FIG. 3 is a sectional view taken along a line A-A of FIG. 2B;

FIG. 4 is a sectional view taken along a line B-B of FIG. 2B; and

FIG. 5 is a sectional view taken along a line C-C of FIG. 2B.

### DESCRIPTION OF EMBODIMENTS

A connector fitting body 3 including a female housing 7 according to an embodiment of the present invention will be described below with reference to the drawings. The connector fitting body 3 is constituted by a male connector 1 and a female connector 2. When a male housing 4 of the male connector 1 and the female housing 7 of the female connector 2 are fitted to each other, electric wires 6 connected to male terminals 5 received in the male housing 4 and electric wires 9 connected to female terminals 8 received in the female housing 7 are electrically connected to each other.

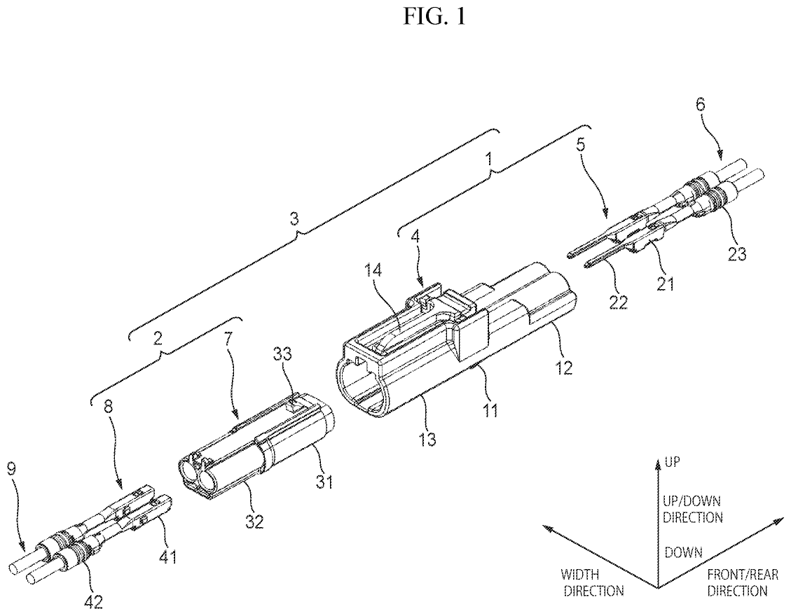

As shown in FIG. 1, “front/rear direction”, “width direction”, “up/down direction”, “up” and “down” will be defined below for convenience of explanation. The “front/rear direction”, the “width direction” and the “up/down direction” intersect perpendicularly to one another. The front/rear direction is consistent with a fitting direction between the male connector 1 (the male housing 4) and the female connector 2 (the female housing 7), an insertion direction of the male terminals 5 into the male housing 4, and an insertion direction of the female terminals 8 into the female housing 7. As to each of the male connector 1 and the female connector 2, a front face side in an insertion direction in which a mated connector is inserted is defined as front side, and a back face side opposite to the front face side in the insertion direction is defined as rear side. First, the male connector 1 will be described below.

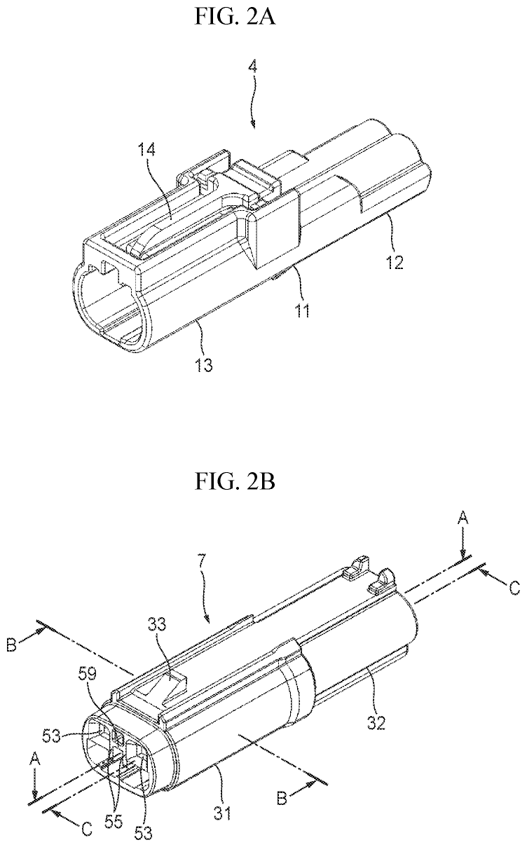

As shown in FIG. 1 and FIG. 2A, the male connector 1 is constituted by the male housing 4 made of a resin, and the male terminals 5 paired with each other. The male housing 4 is provided with a base portion 11, an electric wire retention portion 12, and a hood portion 13 integrally. The electric wire retention portion 12 extends rearward from the base portion 11. The hood portion 13 extends frontward from the base portion 11.

Paired terminal reception chambers (not shown) penetrating the base portion 11 in the front/rear direction are formed inside the base portion 11 so as to be arranged side by side in the width direction. Paired terminal insertion holes (not shown) penetrating the electric wire retention portion 12 in the front/rear direction are formed inside the electric wire retention portion 12 so as to be arranged side by side in the width direction and so as to communicate with the paired terminal reception chambers respectively. The hood portion 13 has a cylindrical shape protruding frontward while surrounding front end portions of the paired terminal reception chambers.

Each of the male terminals 5 has a body portion 21 and a rod-like tab portion 22. The body portion 21 extends in the front/rear direction. The rod-like tab portion 22 protrudes frontward from the body portion 21. An end of a corresponding one of the electric wires 6 is connected to a rear side of the body portion 21. An annular rubber plug 23 is attached to the end of the corresponding electric wire 6.

The paired male terminals 5 to which the electric wires 6 have been connected are inserted from the rear into the male housing 4 and received therein. At a stage halfway through the reception of the male terminals 5, lances (not shown) provided in the terminal reception chambers are elastically deformed in a direction to leave the body portions 21 of the male terminals 5. In a state in which the male terminals 5 have been completely received, the lances provided in the terminal reception chambers are elastically recovered in a direction to approach the body portions 21 of the male terminals 5 to thereby lock steps (not shown) of the body portions 21 of the male terminals 5. Thus, the male terminals 5 are prevented from dropping out of the male housing 4 toward the rear.

In the state in which the paired male terminals 5 have been received completely, the body portions 21 of the paired male terminals 5 are received in the paired terminal reception chambers of the base portion 11. The tab portions 22 of the paired male terminals 5 protrude frontward from front end portions of the paired terminal reception chambers to be positioned inside an internal space of the hood portion 13. Ends of the paired electric wires 6 connected to the paired male terminals 5 are received and retained in the paired terminal insertion holes of the electric wire retention portion 12. Thus, the body portions 21 of the male terminals 5 are received in the terminal reception chambers of the base portion 11 after passing through the terminal insertion holes of the electric wire retention portion 12.

At a stage where the male terminals 5 have been received completely, gaps between outer circumferential faces of the ends of the electric wires 6 and inner circumferential faces of the terminal insertion holes of the electric wire retention portion 12 are sealed by the rubber plugs 23. Thus, water can be prevented from entering the male housing 4 from the rear side of the male housing 4.

Next, the female connector 2 will be described. As shown in FIG. 1 and FIG. 2B, the female connector 2 is constituted by the female housing 7 made of a resin, and the female terminals 8 paired with each other. The female housing 7 is provided with a base portion 31 and an electric wire retention portion 32 integrally. The electric wire retention portion 32 extends rearward from the base portion 31.

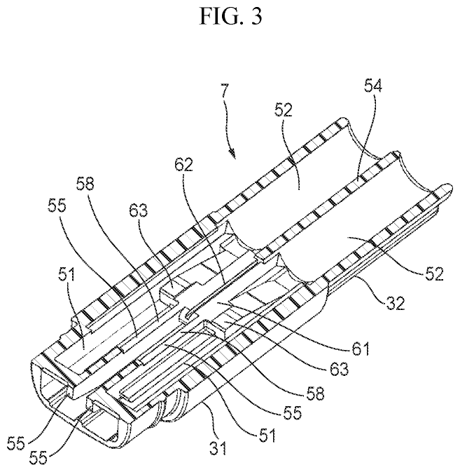

As shown in FIG. 3 to FIG. 5 (particularly, FIG. 3), paired terminal reception chambers 51 penetrating the base portion 31 in the front/rear direction are formed inside the base portion 31 so as to be arranged side by side in the width direction. Paired terminal insertion holes 52 penetrating the electric wire retention portion 32 in the front/rear direction are formed inside the electric wire retention portion 32 so as to be arranged side by side in the width direction and so as to communicate with the paired terminal reception chambers 51 respectively. Incidentally, an internal structure of the female housing 7 will be described in detail later.

As shown in FIG. 1, each of the female terminals 8 has a cylindrical body portion 41 which extends in the front/rear direction. An end of a corresponding one of the electric wires 9 is connected to a rear side of the body portion 41. An annular rubber plug 42 is attached to the end of the corresponding electric wire 9.

The paired female terminals 8 to which the electric wires 9 have been connected are inserted from the rear into the female housing 7 and received therein. At a stage halfway through the reception of the female terminals 8, lances 63 (see FIG. 3 to FIG. 5. Details will be described later) provided in the terminal reception chambers 51 are elastically deformed in a direction (downward direction) to leave the body portions 41 of the female terminals 8. In a state in which the female terminals 8 have been received completely, the lances 63 are elastically recovered in a direction (upward direction) to approach the body portions 41 of the female terminals 8 to thereby lock steps (not shown) of the body portions 41 of the female terminals 8. Thus, the female terminals 8 can be prevented from dropping out of the female housing 7 toward the rear.

In the state in which the paired female terminals 8 have been received completely, the body portions 41 of the paired female terminals 8 are received in the paired terminal reception chambers 51 of the base portion 31. Ends of the paired electric wires 9 connected to the paired female terminals 8 are received and retained in the paired terminal insertion holes 52 of the electric wire retention portion 32. Thus, the body portions 41 of the female terminals 8 are received in the terminal reception chambers 51 of the base portion 31 after passing through the terminal insertion holes 52 of the electric wire retention portion 32.

At a stage where the female terminals 8 have been received completely, gaps between outer circumferential faces of the ends of the electric wires 9 and inner circumferential faces of the terminal insertion holes 52 of the electric wire retention portion 32 are sealed by the rubber plugs 42. Thus, water can be prevented from entering the female housing 7 from the rear side of the female housing 7.

Fitting between the male housing 4 and the female housing 7 can be accomplished by inserting the base portion 31 of the female housing 7 into the hood portion 13 of the male housing 4 and making a front end face of the base portion 31 of the female housing 7 and a front end face of the base portion 11 of the male housing 4 butt against each other inside the hood portion 13. In a state in which the male housing 4 and the female housing 7 have been completely fitted to each other, the tab portions 22 of the male terminals 5 received in the male housing 4 are inserted in the cylindrical body portions 41 of the female terminals 8 received in the female housing 7. Thus, the electric wires 6 connected to the male terminals 5 and the electric wires 9 connected to the female terminals 8 are electrically connected to each other.

Further, a lock arm 14 (see FIG. 1 and FIG. 2A) formed in the male housing 4 is engaged with a lock beak 33 (see FIG. 1 and FIG. 2B) formed in the female housing 7. Thus, the male housing 4 and the female housing 7 are maintained at the completely fitted state.

Incidentally, it is preferable that the male housing 4 and the female housing 7 are configured so that the function of preventing water from entering the male housing 4 and the female housing 7 from outside through a gap between the front end face of the base portion 31 of the female housing 7 and the front end face of the base portion 11 of the male housing 4 made to butt against each other can be exerted in the completely fitted state between the male housing 4 and the female housing 7.

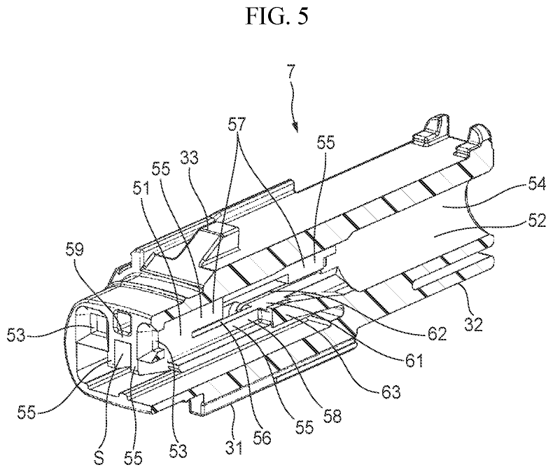

The internal structure of the female housing 7 will be described in detail with reference to FIG. 3 to FIG. 5. As described above, the paired terminal reception chambers 51 of the base portion 31 communicate with the paired terminal insertion holes 52 of the electric wire retention portion 32. Paired insertion holes 53 (see FIG. 2B and FIG. 5) for inserting the tab portions 22 of the male terminals 5 on the male connector 1 side are formed in front end portions of the paired terminal reception chambers 51.

The paired terminal insertion holes 52 on the rear side of the female housing 7 are partitioned by a single first partition wall 54. The first partition wall 54 extends in the front/rear direction in a width-direction central portion of the electric wire retention portion 32.

The paired terminal reception chambers 51 on the front side of the female housing 7 are partitioned by paired second partition walls 55. The paired second partition walls 55 extend in the front/rear direction in a width-direction central portion of the base portion 31. The paired second partition walls 55 are suspended downward from an upper wall of the base portion 31 to extend to an up/down-direction halfway position inside the base portion 31 so that the second partition walls 55 are opposed to each other with a predetermined distance left therebetween in the width direction (see FIG. 5).

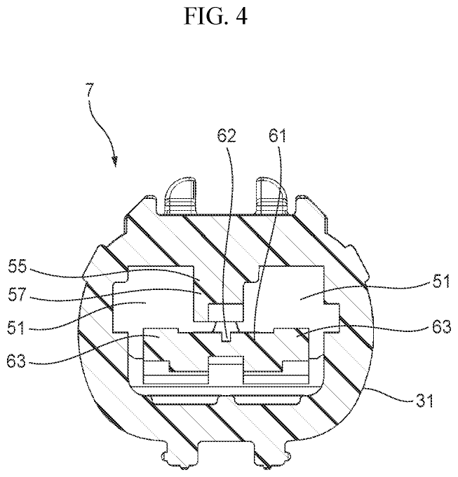

A slit 56 is formed in each of the second partition walls 55. The slit 56 extends frontward from a rear end of an up/down-direction central portion of the second partition wall 55 to a front/rear-direction halfway position of the up/down-direction central portion of the second partition wall 55 (see FIG. 5). As a result, the second partition wall 55 includes an upper wall portion 57 (see FIG. 4 and FIG. 5) and an arm portion 58 shaped like a double-end supported beam (see FIG. 3 and FIG. 5). The upper wall portion 57 is positioned on an upper side of the slit 56 and fixed inside the base portion 31. The arm portion 58 is positioned in a lower portion of the slit 56 and can be elastically deformed downward inside the base portion 31.

The paired upper wall portions 57 are coupled to each other in the width direction by a plate-like portion 59 (see FIG. 2B and FIG. 5). The plate-like portion 59 extends in the front/rear direction between the paired upper wall portions 57. Rear end portions of the paired arm portions 58 are coupled to each other in the width direction by a front end portion of a coupling portion 61 (see FIG. 3 to FIG. 5) extending in the front/rear direction. A rear end portion of the coupling portion 61 is connected to the first partition wall 54, as shown in FIG. 3. Here, it can be interpreted that the coupling portion 61 constitutes portions of the paired second partition walls 55.

A groove 62 is formed in a width-direction central portion in an upper face of the coupling portion 61 to extend over an entire region in the front/rear direction (see FIG. 3 to FIG. 5). A thin portion extending in the front/rear direction is formed in the width-direction central portion of the coupling portion 61 due to the formation of the groove 62.

The lance 63 extending obliquely frontward and upward from a lower wall of a rear end portion of each of the terminal reception chambers 51 (a boundary portion between the terminal reception chamber 51 and the terminal insertion hole 52) is formed in the terminal reception chamber 51 (see FIG. 3 to FIG. 5). A width-direction inner end portion of each of the lances 63 is connected to a corresponding width-direction outer end portion in the coupling portion 61.

In other words, the paired lances 63 provided in the paired terminal reception chambers 51 are coupled to each other in the width direction by the coupling portion 61. As a result, the lances 63 are elastically deformed downward together with the coupling portion 61 and the arm portions 58. Further, the coupling portion 61 is connected to the first partition wall 54. Therefore, strength, rigidity, or the like of each of the lances 63 is enhanced in comparison with that in a case where the paired lances 63 are independent of each other.

Incidentally, to remove both the paired female terminals 8 in a state in which the paired female terminals 8 have been received in the paired terminal reception chambers 51 (i.e. a state in which the lances 63 have been locked to the steps of the body portions 41 of the female terminals 8 corresponding thereto respectively), an unlocking rod-like jig (not shown) is inserted from the front into the female housing 7 through a space S shown in FIG. 5. In a state in which a distal end portion (rear end portion) of the jig has been made to abut against the width-direction central portion of the upper face of the coupling portion 61 (i.e. a position right above the groove 62) and an extension-direction central portion of the jig has been made to abut against a lower face of the plate-like portion 59, a proximal end portion (a front end portion protruding frontward from a front end portion of the female housing 7) of the jig is pushed up against the female housing 7. As a result, the coupling portion 61 can be easily pushed down by a so-called “principle of leverage” where the distal end portion of the jig serves as an action point and the extension-direction central portion of the jig serves as a fulcrum.

On this occasion, the width-direction central portion of the coupling portion 61 is pushed down. Accordingly, the coupling portion 61 as a whole makes parallel motion in a downward direction. Thus, both the paired lances 63 are pushed down. As a result, both the paired female terminals 8 are released from being locked by the lances 63. Accordingly, both the paired female terminals 8 can be removed (detached rearward).

On the other hand, to remove, of the female terminals 8, only a female terminal 8 on one side in the width direction (but not to remove a female terminal 8 on the other side) in the state in which the paired female terminals 8 have been received in the paired terminal reception chambers 51 (i.e. the state in which the lances 63 have been locked to the steps of the body portions 41 of the female terminals 8 correspondingly), the proximal end portion (front end portion) of the jig is pushed up against the female housing 7 in a state in which the distal end portion (the rear end portion) of the jig which has been inserted in the female housing 7 has been made to abut against an end portion of the upper face of the coupling portion 61 on one side in the width direction.

As a result, of the coupling portion 61, a portion on one side in the width direction with respect to the width-direction central portion is pushed down while the coupling portion 61 is curved in the groove 62 (the thin portion) in a direction to widen a width-direction interval between paired side walls of the groove 62. Thus, of the coupling portion 61, the portion on the other side in the width direction with respect to the width-direction central portion is substantially hardly pushed down. That is, only the lance 63 on one side in the width direction is pushed down while the lance 63 on the other side in the width direction is substantially hardly pushed down. As a result, locking by the lance 63 on one side in the width direction is cancelled. Accordingly, the female terminal 8 on one side in the width direction can be removed (detached rearward). On the other hand, a problem such as positional displacement of the female terminal 8 on the other side in the width direction can be prevented from occurring easily.

According to the female housing 7 according to the embodiment of the present invention as described above, the paired lances 63 provided in the paired terminal reception chambers 51 adjacent to each other are coupled to each other by the coupling portion 61. Further, the coupling portion 61 is connected to the first partition wall 54 partitioning the paired terminal insertion holes 52. Therefore, strength, rigidity, or the like of each of the lances 63 is enhanced in comparison with that in a case where the paired lances 63 are independent of each other. Accordingly, locking force generated by each of the lances 63 can be enhanced. Further, the thin portion (the portion corresponding to the groove 62) extending along a direction (the front/rear direction) in which the female terminals 8 are received is provided in the coupling portion 61. Accordingly, when only one female terminal 8 is removed in a state in which the female terminals 8 have been received in both the terminal reception terminals 51, external force for releasing the one female terminal 8 from being locked is applied to only the lance 63 corresponding thereto. In this case, the coupling portion 61 is curved in the thin portion (the groove 62) so that the external force is prevented from being easily transmitted to the other lance 63. Therefore, it is possible to suppress the problem such as unintentional positional displacement of the other female terminal 8 in a process of removing the one female terminal 8.

Thus, the female housing 7 according to the embodiment of the present invention can also suppress the paired lances 63 from unintentionally interlocking with each other by use of the coupling portion 61 while securing lock force generated by the lances 63 by use of the coupling portion 61 even if the size of each of the lances 63 is reduced as the size of the female housing 7 is reduced. Accordingly, the female housing 7 can properly retain the female terminals 8 inside the terminal reception chambers 51 compatibly with reduction in size of the female housing 7.

Further, according to the female housing 7 according to the embodiment of the present invention, the coupling portion 61 serves as portions of the second partition walls 55 partitioning the paired terminal reception chambers 51. Therefore, the portions of the second partition walls 55 partitioning the adjacent terminal reception chambers 51 can be used as the coupling portion 61. Accordingly, the size of the female housing 7 can be further reduced in comparison with that in a case where the coupling portion 61 is provided as another independent member than the second partition walls 55.

Further, according to the female housing 7 according to the embodiment of the present invention, the thin portion (the groove 62) is disposed in the width-direction central portion of the coupling portion 61. Therefore, an effect of suppressing the paired lances 63 from interlocking with each other can be exerted on each of the paired lances 63 without any bias.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

In the aforementioned embodiment, the coupling portion 61 serves as the portions of the second partition walls 55 partitioning the paired terminal reception chambers 51. On the other hand, the coupling portion 61 may be provided as another independent member than the second partition walls 55.

Further, in the aforementioned embodiment, the thin portion (i.e. the groove 62) is disposed in the width-direction central portion of the coupling portion 61. On the other hand, the thin portion (i.e. the groove 62) may be disposed at a position closer to one side of the coupling portion 61 in the width direction with respect to the width-direction central portion. Thus, an effect of suppressing the paired lances 63 from interlocking with each other can be intentionally biased between the paired lances 63.

Further, in the aforementioned embodiment, the groove 62 extending in the front/rear direction in order to form the thin portion is formed in the upper face of the coupling portion 61. On the other hand, the groove 62 extending in the front/rear direction in order to form the thin portion may be formed in a lower face of the coupling portion 61 or may be formed in both the upper face and the lower face of the coupling portion 61. In addition, the thin portion may be constituted by any other form than the groove.

According to the above exemplary embodiments, a connector housing (7) comprises:

a plurality of terminal reception chambers (51);

a plurality of terminal insertion holes (52) each being located to communicate with each of the plurality of the terminal reception chambers (51), the plurality of the terminal insertion holes (52) each being configured to allow each terminal (8) to be received in each of the terminal reception chambers (51) to pass through its inside before the each of the terminal being received in the each of the terminal reception chambers (51);

a plurality of lock portions (63) each being located in each of the plurality of terminal reception chambers (51), the plurality of lock portions (63) each being configured to be elastically deformed in a direction to leave from the each terminal (8) in the middle of reception to the each of the terminal reception chambers (51) and to be elastically recovered in a direction to approach the each terminal (8) to lock the each terminal (8) upon the reception of the each terminal (8) being completed; and

a coupling portion (61) connecting a pair of the lock portions (63) each belonging to each of a pair of the terminal reception chambers (51) located adjacent to each other,

the coupling portion (61) being connected to a first partition wall (54) partitioning a pair of the terminal insertion holes (52) corresponding to the pair of the terminal reception chambers (51), the coupling portion (61) having a groove (62) extending along a direction to receive the each terminal (8).

According to the above-described connector housing, the paired lock portions (e.g. lances) provided in the paired terminal reception chambers adjacent to each other are coupled to each other by the coupling portion. Further, the coupling portion is connected to the partition wall (the first partition wall) for the terminal insertion holes communicating with the terminal reception chambers. Therefore, strength, rigidity, or the like of each of the lock portions is enhanced in comparison with that in a case where the paired lock portions are independent of each other. Accordingly, lock force attained by each of the lock portions can be enhanced. Further, the coupling portion has the groove (i.e., thin portion) extending in the direction in which the terminals are received. For example, assume that the terminals have been received in both the terminal reception chambers due to action of the thin portion. In this case, when external force is applied to unlock only one of the lock portions in order to remove one of the terminals, the thin portion is curved to thereby prevent the external force from being easily transmitted to the other lock portion. Accordingly, it is possible to suppress occurrence of a problem such as unintentional displacement (positional shift) of the other terminal from a predetermined lock position in a process of removing the one terminal.

According to the connector housing having the present configuration, even if the size of each of the lock portions is reduced as the size of the connector housing is reduced, the coupling portion can be used to suppress the paired lock portions from unintentionally interlocking with each other while enhancing the lock force attained by each of the lock portions. Accordingly, the connector housing having the present configuration can properly retain the terminals inside the terminal reception chambers compatibly with reduction in size of the connector housing.

In the connector housing (7),

the coupling portion (61) may be connected to a portion of a second partition wall (55) partitioning the pair of the terminal reception chambers (51).

According to the above-described connector housing, the portions of the partition walls (the second partition walls) partitioning the adjacent terminal reception chambers can be used as the coupling portion. Accordingly, the size of the connector housing can be further reduced in comparison with that in a case where the coupling portion is separately provided as another independent member than the partition walls.

In the connector housing (7),

the groove (62) may be located at the center of the coupling portion (61) in a direction where the pair of the terminal reception chambers (51) are arranged side by side.

According to the above connector housing, the groove is provided at the center of the coupling portion in the direction in which the paired terminal reception chambers are arranged side by side. Thus, an effect of suppressing the lock portions from unintentionally interlocking can be exerted without any bias w % bile the lock force attained by each of the paired lock portions is made uniform.

In the connector housing (7),

the coupling portion (61) may be configured to be abutted with an unlocking jig to release the each terminal (8) from being locked by the pair of the lock portions (63).

According to the present invention, it is possible to provide a connector housing which can properly retain the terminals inside the terminal reception chambers compatibly with reduction in size of the connector housing.

The connector housing according to the invention can properly retain the terminals inside the terminal reception chambers compatibly with reduction in size of the connector housing. The invention having this effect is useful for, for example, the connector housing.

What is claimed is:

1. A connector housing comprising:
a plurality of terminal reception chambers;
a plurality of terminal insertion holes each being located to communicate with each of the plurality of the terminal reception chambers, the plurality of the terminal insertion holes each being configured to allow each terminal to be received in each of the terminal reception chambers to pass through its inside before the each terminal being received in the each of the terminal reception chambers;
a plurality of lock portions each being located in each of the plurality of terminal reception chambers, the plurality of lock portions each being configured to be elastically deformed in a direction to leave from the each terminal in the middle of reception to the each of the terminal reception chambers and to be elastically recovered in a direction to approach the each terminal to lock the each terminal upon the reception of the each terminal being completed; and
a coupling portion connecting a pair of the lock portions each belonging to each of a pair of the terminal reception chambers located adjacent to each other,
the coupling portion being connected to a first partition wall partitioning a pair of the terminal insertion holes corresponding to the pair of the terminal reception chambers, the coupling portion having a groove extending along a direction to receive the each terminal.

2. The connector housing according to claim 1, wherein
the coupling portion is connected to a portion of a second partition wall partitioning the pair of the terminal reception chambers.

3. The connector housing according to claim 1, wherein
the groove is located at the center of the coupling portion in a direction where the pair of the terminal reception chambers are arranged side by side.

4. The connector housing according to claim 1, wherein
the coupling portion is configured to be abutted with an unlocking jig to release the each terminal from being locked by the pair of the lock portions.
